(19) United States
(12) Patent Application Publication
(10) Pub. No.: US 2023/0182134 A1
(43) Pub. Date: Jun. 15, 2023

(54) CENTRIFUGAL DETECTION CHANNEL, DETECTION DEVICE AND DETECTION METHOD

(71) Applicant: Zhejiang PushKang Biotechnology Co., LTD., Shaoxing City, Zhejiang Province (CN)

(72) Inventors: YI-XIANG ZHAO, Taichung City (TW); BO YU, Shaoxing City, Zhejiang Province (CN); YUAN-TING CHENG, Taichung City (TW); CHIH-HSIN SHIH, Taichung City (TW); SHI-XIAO ZHANG, Shaoxing City, Zhejiang Province (CN); LIN CHENG, Shaoxing City, Zhejiang Province (CN)

(21) Appl. No.: 17/924,114

(22) PCT Filed: May 29, 2020
(86) PCT No.: PCT/CN2020/093226

§ 371 Date: Nov. 8, 2022

(30) Foreign Application Priority Data
May 8, 2020 (CN) 202010384473.1

(51) Int. Cl. B01L 3/00; G01N 35/10

(52) U.S. Cl. CPC B01L 3/502738; G01N 35/1002; G01N 2035/00495

(57) ABSTRACT

The present invention discloses a kind of centrifugal detection channel, including: a first chamber, at least one inlet channel, at least one buffer valve, at least one outlet channel, and a second chamber. Specifically, at least one inlet channel is connected to the first chamber. At least one buffer valve is connected to the inlet channel, including: a valve body and a transient chamber. At least one outlet channel is connected to the buffer valve. At least one second chamber is connected to the outlet channel. In addition, the detection devices and the detection methods comprising the centrifugal detection channel have also been proposed.

This application claims the benefit of Chinese Patent Application No. 202010384473.1, filed on May 8, 2020, the disclosure of which is incorporated herein in its entirety by reference.

### TECHNICAL FIELD

The present invention provides a centrifugal detection channel, detection device and detection method thereof, especially for being capable of performing the detection on single reagent or multiple reagents.

### BACKGROUND OF RELATED ARTS

Facing with the current challenges in the fields of biomedical analysis, disease diagnosis, environmental monitoring, as well as food and drug safety, there are higher requirements concerning methods and equipment for detection analysis. To meet these new demands, it is necessary to develop miniaturized, integrating, and portable sample detection equipment.

The commercial automatic analysis equipment used in sample detection, such as automatic biochemical analyzer, realizes the steps of sampling, adding reagents, mixing, heat preservation, colorimetry, calculation and reporting of the outcome in biochemical analysis all by the machinery imitating the manual operation. However, the current automatic analyzers are bulky, expensive, and complicated to operate. Furthermore, it is also required to be configured with technical equipment for sample pre-treating, which are generally installed in the central laboratory of a large hospital, that are operated by experts. Additionally, in order to improve the detection efficiency and to reduce the cost of testing, it is necessary to collect a large number of quantitative samples. Therefore, the large-scale automated analyzer used in hospitals cannot meet the needs of on-site sampling and analysis, rapid testing, and patient self-tests.

On the other hand, when microfluidic products manipulate microfluidics, it is often necessary to fix the liquid at a specific position for incubation, reaction and detection. In this aspect, some unique structures are required to prevent the liquid from continuing to move forward, so as to avoid initiating subsequent processes or reagent reactions ahead of time. Currently, there are common microfluidic valves such as hydrophobic valves, wax valves, mechanical valves, or soluble membrane valves, to name a few. In terms of hydrophobic valves, a hydrophobic agent is required to be modified to increase the contact angle and increase the surface tension to prevent the liquid from flowing. However, the yield of hydrophobically modified products is not high, which increases the difficulty of production. In terms of the wax valves, the wax is sealed into the disc to form a wax valve, and a precisely positioned infrared heating device is required to successfully melt the targeted wax valve without affecting other valves. In terms of mechanical valves, a precisely positioning device is also required, and the mechanical column abutting the deformable membrane prevents the liquid from advancing. In terms of the soluble membrane valves, the soluble membrane is relied upon such that the liquid can move forward once the membrane melts upon the liquid touching the soluble membrane. Nonetheless, the cost of the soluble membrane is high, and it is difficult to be packaged. The valve bodies mentioned above all require additional processing or additional devices, which will increase production steps, increase cost, and reduce yield rate.

What is more, although the detection equipment of the prior art can detect multiple indicators, given that there is only one reaction chamber, only a single reagent can be detected, and the successive detection of multiple reagents fails to be realized.

### SUMMARY

In order to solve the problems mentioned in the prior art, the present invention proposes a centrifugal detection channel, a detection device and a detection method. By utilizing a unique buffer control valve, it can prevent the liquid from advancing without additional processing and devices with the action of surface tension and air pressure. In addition, the transient chamber in the buffer control valve can hold the dripping liquid as buffering during the process to prevent the liquid from entering the subsequent chamber too early. Accordingly, the transient chamber concurrently functions as valve and buffering.

First, a centrifugal detection channel proposed by the present invention includes: a first chamber, at least one inlet channel connected to the first chamber, at least one buffer valve (buffer control valve) connected to the inlet channel, at least one outlet channel connected to the buffer valve, and at least one second chamber connected to the outlet channel. The buffer valve comprises a valve body which is disposed at the upper end of the buffer valve and connected to the inlet channel, and a transient chamber which is disposed at the lower end of the buffer valve.

On the other hand, the centrifugal detection device of the present invention includes: a dispensing channel, a waste chamber connected to the dispensing channel, at least one detection channel which is individually connected to the dispensing channel, an outlet channel connected to the buffer valve, and a second chamber connected to the outlet channel. Each detection channel includes: a first chamber, an inlet channel connected to the first chamber, and a buffer valve connected to the inlet channel. The buffer valve includes: a valve body disposed at the upper end of the buffer valve and connected to the inlet channel, and a transient chamber disposed at the lower end of the buffer valve.

Finally, the centrifugal detection method of the present invention includes the following steps: (A) Centrifuge at a low speed to make a testing sample flow along a dispensing channel to a first chamber for implementing a first reaction, and the excess testing sample flows to a waste chamber, (B) A valve body at the upper end of a buffer valve blocks the testing sample from flowing to a second chamber, (C) A transient chamber at the lower end of the buffer valve stores the dripping testing sample when the air pressure is balanced, and (D) Centrifuge at high speed to make the testing sample in the first chamber flow to the second chamber after the first chamber reaction is completed.

Embodiments of the invention are illustrated by way of example, and not by way of limitation, in the figures of the accompanying drawings in which like reference numerals refer to similar elements.

### BRIEF DESCRIPTION OF THE DRAWINGS

To clearly describe the embodiment of the present application or the technique of the prior art, the following description may illustrate the essential drawings briefly. Obviously, the drawings mentioned as follows are just the embodiments of the present application. For the person having ordinary skill in the art, the drawings may teach them without considering, and figure out the other possible embodiment which may be contained by the present application.

FIG. 1 illustrates a schematic diagram of the first centrifugal detection channel of a preferred embodiment of the present invention.

FIG. 2 illustrates a schematic diagram of the second centrifugal detection channel of the preferred embodiment of the present invention.

FIG. 3 illustrates a schematic diagram of the centrifugal detection channel of the second preferred embodiment of the present invention.

FIG. 4 shows a schematic diagram of the centrifugal detection channel of the third preferred embodiment of the present invention.

FIG. 5 illustrates a schematic diagram of the centrifugal detection channel of the fourth preferred embodiment of the present invention.

FIG. 6 illustrates a schematic diagram of the centrifugal detection device of a preferred embodiment of the present invention.

FIG. 7 shows a flow diagram showing the steps of operating the centrifugal detection device of a preferred embodiment of the present invention.

FIG. 8 illustrates a flow diagram showing the steps of operating the centrifugal detection device of a preferred embodiment of the present invention.

FIG. 9 illustrates a flow diagram showing the steps of operating the centrifugal detection device of a preferred embodiment of the present invention.

FIG. 10 shows another schematic diagram of the centrifugal detection device of a preferred embodiment of the present invention.

FIG. 11 shows a flow diagram of the centrifugal detection method of a preferred embodiment of the present invention.

FIG. 12 shows a schematic diagram of the centrifugal detection system of a preferred embodiment of the invention.

### DETAILED DESCRIPTION OF THE INVENTION

In order to understand the technical features and practical efficacy of the present invention and to implement it in accordance with the contents of the specification, hereinafter, preferred embodiments of the present invention will be described in detail with reference to the accompanying drawings.

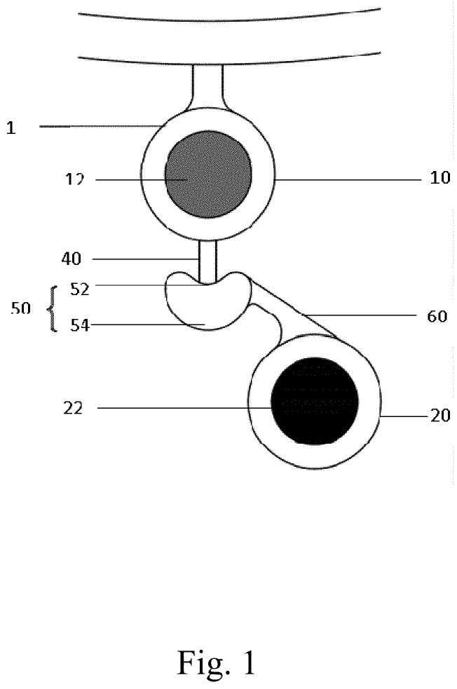

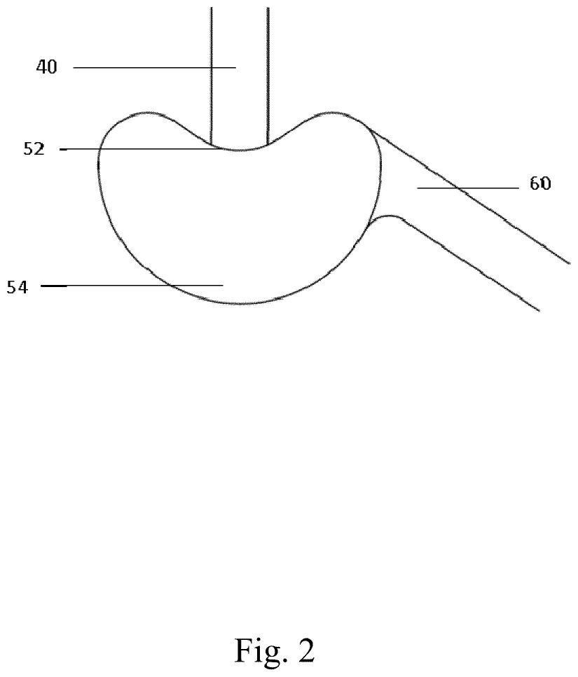

First of all, please refer to the FIG. 1 and FIG. 2. FIG. 1 is a schematic diagram of the first centrifugal detection channel in a preferred embodiment of the present invention, and the FIG. 2 is a schematic diagram of the second centrifugal detection channel in a preferred embodiment of the present invention. As shown in FIG. 1, the first centrifugal detection channel 1 of this embodiment includes a first chamber 10, an inlet channel 40, a buffer valve 50, an outlet channel 60, and a second chamber 20. The inlet channel 40 is connected to the first chamber 10, the buffer valve 50 is connected to the inlet channel 40, the outlet channel 60 is connected to the buffer valve 50, and the second chamber 20 is connected to the outlet channel 60. The second centrifugal detection channel in the FIG. 2 also includes an inlet channel 40, a buffer valve 50 connected to the inlet channel 40. The buffer valve 50 includes: a valve body 52 disposed at the upper end of the buffer valve 50 and connected to the inlet channel 40, and a transient chamber 54 disposed at the lower end of the buffer valve 50. The outlet channel 60 is connected with the buffer valve 50.

Additionally, the first chamber 10 of the first centrifugal detection channel 1 can store (pre-packaged) the first reagent 12, and the second chamber 20 can store (pre- package) the second reagent 22. The first reagent 12 and the second reagent 22 may be lyophilization reagent, volatilizing reagent, packaged liquid reagent or a combination thereof, and may also be NADH Dehydrogenase (NADH), Lactate Dehydrogenase (LDH), Alanine Aminotransferase (ALT), Aspartate Aminotransferase (AST), γ-Glutamyl Transpeptidase (γ-GT), Alkaline Phosphatase (ALP), total bilirubin (TBil), direct bilirubin (DBil), total protein (TP), albumin (Alb), urea (urea), creatinine (Cr), uric acid (UA), glucose (Glu), total cholesterol (TC), triglyceride (TG), high density Lipoprotein (HDL), Very Low Density Lipoprotein (VLDL), Low Density Lipoprotein (LDL), serum magnesium (Mg), serum potassium (K), serum sodium (Na), serum chlorine (Cl), serum calcium (Ca), serum phosphorus (P), serum iron (Fe), serum ammonia (NH₃) or carbon dioxide (CO₂) or other possible enzymes.

Users can pre-package reagents in each chamber based on their needs. For instance, if you need to quickly detect a simple testing sample, you only need to pre-package the first reagent 12 in the first chamber 10 which reacts with the testing sample, perform the test to complete single reagent detection method. If the single-reagent detection method comprises the quantification of the testing sample beforehand, the second reagent 22 can be pre-packaged in the second chamber 20 and the first chamber 10 (without any reagents) serves as a quantitative chamber. In this regard, the testing sample may be prevented from directly contacting and reacting with the reagent 22 in the second chamber 20, causing cross-contamination of the reagent during the quantification process. Finally, part of the testing sample can be detected by the multi-reagent detection method (i.e., the first chamber 10 and the second chamber 20 are pre-loaded with different reagents). For example, the testing sample reacts with the first reagent 12 in the first chamber 10 to eliminate endogenous interference or serve as background detection value, and the reaction-completed testing sample flows to the second chamber 20 for substantive reaction with the second reagent 22 and subsequently the detection in order to implement the multi-reagent detection method. Furthermore, the multi-reagent detection method not only removes the influence of interfering substances, but also achieves the effects of storage stability, blank sample value determination (such as removal of hemolysis, jaundice, or lipemia), and pre-activation of enzymes.

Next, the buffer valve 50 of the first centrifugal detection channel 1 further includes a valve body 52 disposed at the upper end of the buffer valve 50 and connected to the inlet channel 40, and a transient chamber 54 disposed at the lower end of the buffer valve 50. Specifically, an outlet channel 60 is connected to the side of the buffer valve 50 different from the side accommodating the transient chamber 54. One side of the valve body 52 meets the inlet channel 40 at an angle of 30 to 90 degrees, and the depth of the valve body 52 is 0.05 to 10.0 mm, which collectively form as a V shaped or U shaped. The object of the configuration of the buffer valve 50 is that when the detection flow channel 1 is centrifuged at a low speed, the valve body 52 (air valve) in the buffer valve 50 can block the testing sample of the first chamber 10 from the buffer valve 50 through the action of surface tension and atmospheric pressure. In other words, the valve body 52 can prevent the testing sample of the first chamber 10 from flowing into the buffer valve 50 or the second chamber 20, so as to minimize the risk of the cross-contamination of the reagents and deviation of the detection values. When the atmospheric pressure reaches equilibrium, it is inevitable that a small part of the testing sample will drop into the buffer valve 50 through the inlet channel 40 (microfluidic channel). At this time, the transient chamber 54 with an average radius greater than the average radius of the outlet channel can accommodate these testing samples to temporarily store said samples in the buffer valve 50. The valve body 52 can be hydrophobically modified or not be hydrophobically modified, and therefore the modified valve body 52 will increase the action of the surface tension to enhance the tolerance of the valve body 52 to the rotational speed.

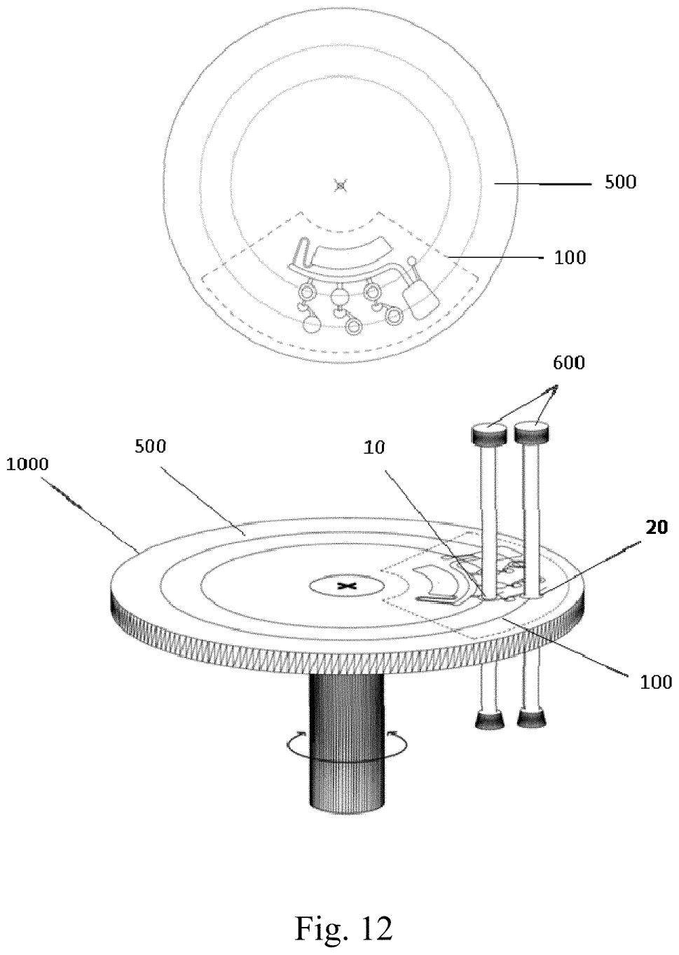

Further, after the testing sample in the first chamber 10 reacts with the first reagent 12 or after the detection pre-warming is completed, the centrifugal platform (FIG. 12) is centrifuged at a high speed to reduce the surface tension and atmospheric pressure of the valve body 52, enabling the testing sample in the first chamber 10 and the inlet channel 40 to flow into the second chamber 20 and react with the second reagent 22 through the buffer valve 50 and the outlet channel 60. Thereafter, the sample is tested after the reaction is completed to fulfil the detection process.

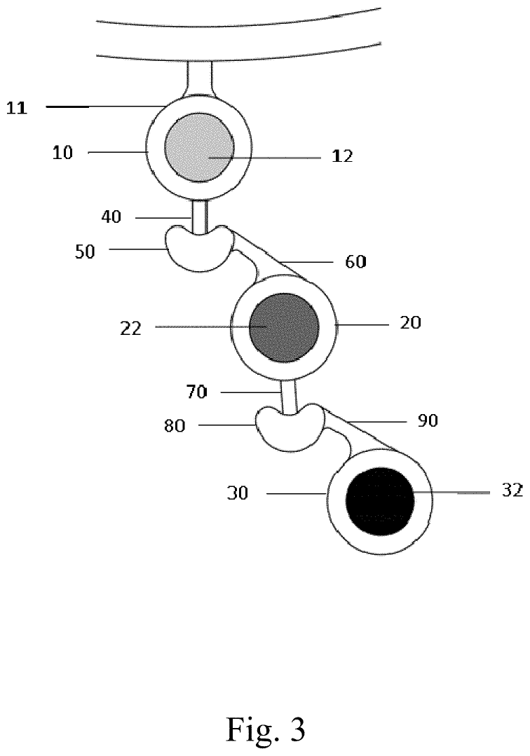

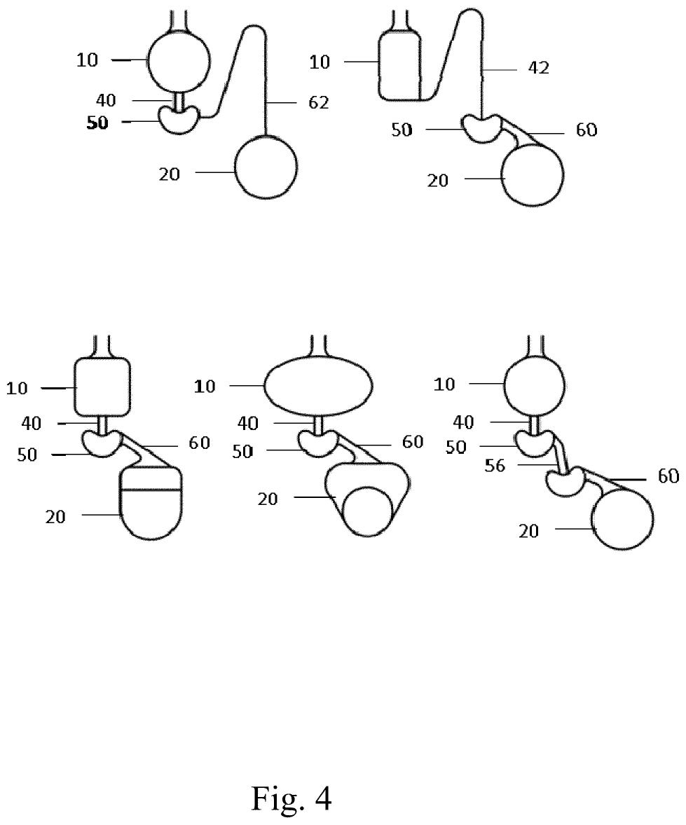

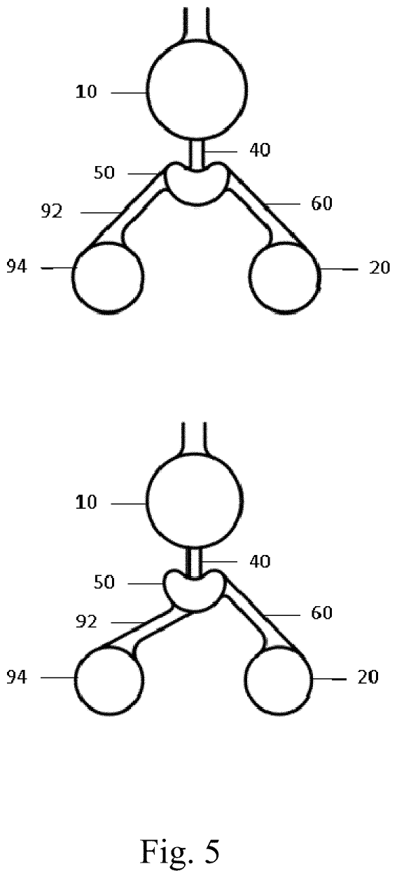

Furthermore, please refer to FIG. 3, FIG. 4 and FIG. 5 at the same time. FIG. 3 is a schematic diagram of the centrifugal detection channel of the second preferred embodiment of the present invention. FIG. 4 is a schematic diagram of the centrifugal detection channel of the third preferred embodiment of the present invention. FIG. 5 is a schematic diagram of a centrifugal detection channel of the fourth preferred embodiment of the present invention. In the embodiment of the FIG. 3, the centrifugal detection channel 11 further includes a second inlet channel 70, a second buffer valve 80, a second outlet channel 90 and/or a third chamber 30. The second inlet channel 70 is connected to the aforementioned second chamber 20, and the second buffer valve 80 is connected to the second inlet channel 70. Likewise, the second buffer valve 80 also includes a valve body and a transient chamber. The second outlet channel 90 is connected to the second buffer valve 50. The third chamber 30 is connected to the second outlet channel 90, and a third reagent 32 can be pre-packaged therein.

It could be known from the above description that the centrifugal detection channel proposed by the present invention not only includes single reagent or dual reagent but can increase the number of chambers and reagents (e.g., inlet channel, buffer valve and outlet channel) based on the detection requirements of the sample in order to realize the design of the multi-reagent detection channel. In fact, the operation principle of the multi-reagent detection channel is the same as the dual-reagent detection channel. There is a buffer valve configured between the two chambers to avoid the test sample flowing into the next chamber and affecting the test results before the reaction is completed.

As illustrated in the embodiment of FIG. 4, the inlet channel and outlet channel of the present invention used to connect the chamber and the buffer valve may not only be the general microfluidic channels 40 and 60, but also may be replaced with capillary tubes 42, 62. Otherwise, the structure of the inlet channel or the outlet channel (e.g., microfluidic channel 40, 60 or capillary tube 42, 62) is not limited, such that any channel that can transport the testing sample should fall within the scope of the present invention. On the other hand, the volume of the chambers in the centrifugal detection channel of the present invention can also be adjusted according to the requirements of the user or the limitation of the testing sample, and the present invention should not be limited.

Finally, as shown in the FIG. 5, if the liquid in the first chamber 10 (whether it is a testing sample in a single-reagent detection channel, or a testing sample that reacts with the first reagent in a dual-reagent detection channel) serves as a background detection sample, and then the liquid in the second chamber 20 serves as a reaction sample. The detection equipment can acquire the background detection value and the reaction value based on the background detection sample and the reaction sample to facilitate subsequent experimental analysis. However, portions of the detection equipment solely allow sample collection at the same horizontal position or the same radius. In other words, if the locations of the first chamber 10 and the second chamber 20 are not at the same horizontal position or radius, additional equipment is required, which causes cost loss.

Therefore, the centrifugal detection channel in this embodiment further includes a background channel 92 connected to the buffer valve 50 and a background chamber 94 connected to the background channel 92. Specifically, the background channel 92 is opposite to the outlet channel 60 side (that is, close to the side of the transient chamber 54) is connected to the buffer valve 50. Accordingly, when the detection flow channel is centrifuged at a low speed, the valve body 52 (air valve) in the buffer valve 50 can block the testing sample in the first chamber 10 from the buffer valve 50 through the action of surface tension and atmospheric pressure. When the atmospheric pressure reaches equilibrium, a part of the testing sample will drop into the buffer valve 50 via the inlet channel 40 (microfluidic channel) and flow downstream to the background chamber 94 via the background channe192. Also, once the reaction between the testing sample and the first reagent 12 in the first chamber 10 has completed (if there is no first reagent, this step is unnecessary), centrifuge at high speed to reduce the action of the surface tension and atmospheric pressure within the valve body 52, so that the testing samples in the first chamber 10 and the inlet channel 40 flow into the second chamber 20 and react with the second reagent 22. Meanwhile, the liquid in the background chamber 94 can be the testing sample in the single-reagent detection channel, or the testing sample that reacts with the first reagent 12 in the dual-reagent detection channel. The liquid in the second chamber 20 is the testing sample that reacts with the second reagent 22. In other words, detection equipment can collect samples at the same horizontal position or at the same radius.

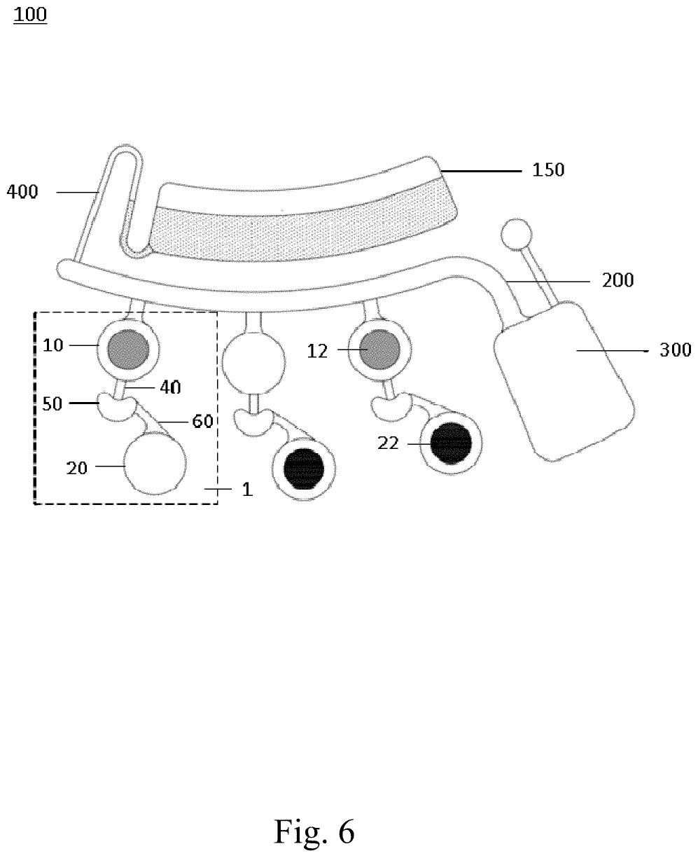

Next, please refer to FIG. 6, which is a schematic diagram of a centrifugal detection device according to a preferred embodiment of the present invention. As shown in FIG. 6, the centrifugal detection device 100 of this embodiment includes a dispensing channel 200, a waste chamber connected to the dispensing channel, at least one centrifugal detection channel 1 individually connected to the dispensing channel 200. Each centrifugal detection channel 1 includes: a first chamber 10, an inlet channel 40 connected to the first chamber 10, a buffer valve 50 connected to the inlet channel 40. The buffer valve 50 includes a valve body 52 disposed at the upper end of the buffer valve 50 and connected to the inlet channel 40 as well as a transient chamber 54 disposed at the lower end of the buffer valve 50. An outlet channel 60 is connected to the buffer valve 50, and a second chamber 20 is connected to the outlet channel 60. The centrifugal detection device 100 may further include a waste chamber 300 connected to the dispensing channel 200 and a chamber 150 connected to the dispensing channel 200 by a capillary tube 400.

In this embodiment, the number of chambers 10 and 12 included in each centrifugal detection channel 1 is two. In other possible implementations, each centrifugal detection channel 1, as shown in FIG. 3, can also include a second inlet channel 70, a second buffer valve 80, a second outlet channel 90 and/or a third chamber 30 (the third chamber 30 can store a third reagent 32). The actual number of chambers can be modified based on the user's needs or the limit of the testing sample, and the present invention should not be limited by the above.

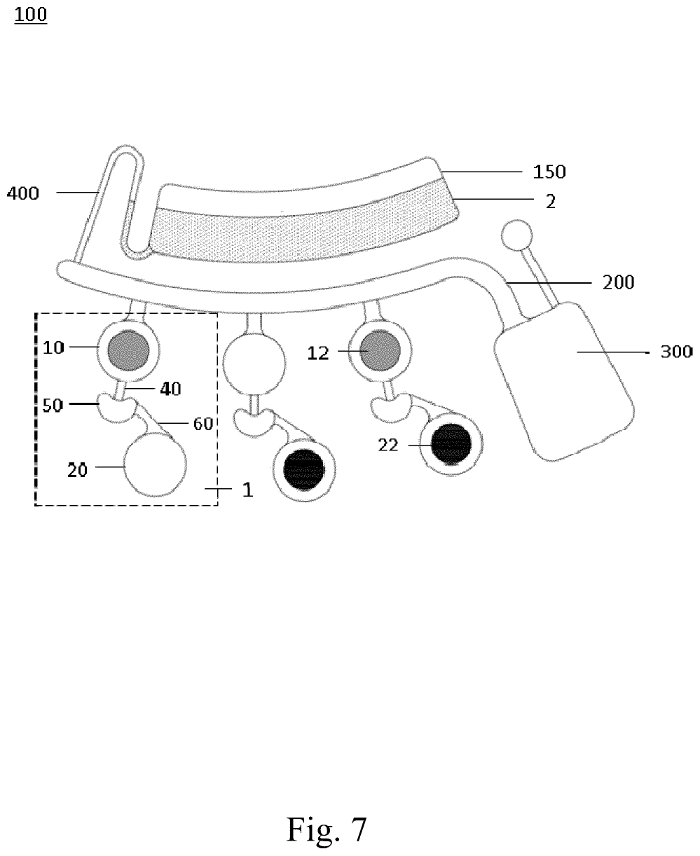

Hereinafter, the operation process of the centrifugal detection device of the preferred embodiment of the present invention will be further elaborated as illustrated in FIG. 7 to FIG. 9. First, in this embodiment, the centrifugal detection device 100 has three detection channels 1. Among the three detection channels 1, the first and second detection channels counted sequentially from the left are single reagent detection channels. Further, the first detection channel is only pre-packaged with the first reagent 12 in the first chamber 10, and the second detection flow channel is only pre-packaged with the second reagent 22 in the second chamber 20. Otherwise, the third detection channel is a dual-reagent detection channel. In the dual-reagent detection channel, the first reagent 12 is pre-packaged in the first chamber 10, and the second reagent 22 is pre-packaged in the second chamber 20.

In FIG. 7, the user or the injection machine injects the testing sample 2 into the chamber 150 and the users places the centrifugal detection device 100 onto a centrifugal platform (FIG. 12), applying high-speed centrifugation to make the testing sample 2 flow into the capillary tube 400.

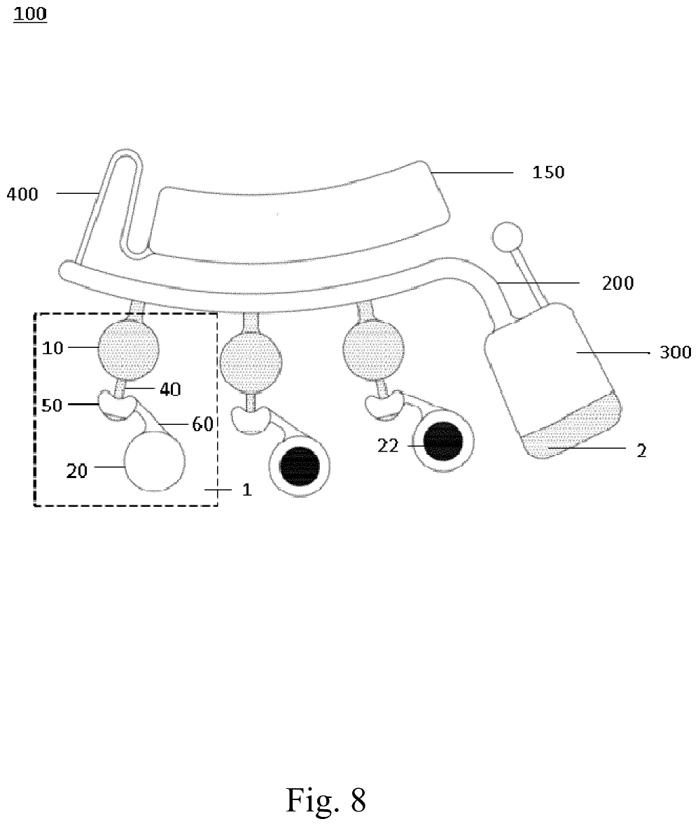

Next, FIG. 8 demonstrates that the centrifugal detection device 100 is in a low-speed centrifugal state, so that the testing sample 2 flows into the dispensing channel 200 along the capillary tube 400, and the testing sample 2 stored in the dispensing channel 200 flows to the first chambers 10 of the first to third detection channels 1 in sequence. Testing samples 2 of the first chambers 10 from the first and third detection channels perform a first reaction with the first reagent 12, while the testing sample 2 of the second detection channel does not react with the first reagent 12. The excess testing sample 2 flows to the waste chamber 300 through the dispensing channel 200.

Furthermore, in this step, the valve body 52 at the upper end of the buffer valve 50 (refer to FIG. 2) will block the testing sample 2 from flowing to the second chamber 20, and the transient chamber 54 at the lower end of the buffer valve 50 is used to store the testing sample 2 that may drop when the pressure is balanced, such that the contact reaction between the testing sample 2 and the reagent 22 in the second chamber 20 is avoided, which would cause cross-contamination of reagents.

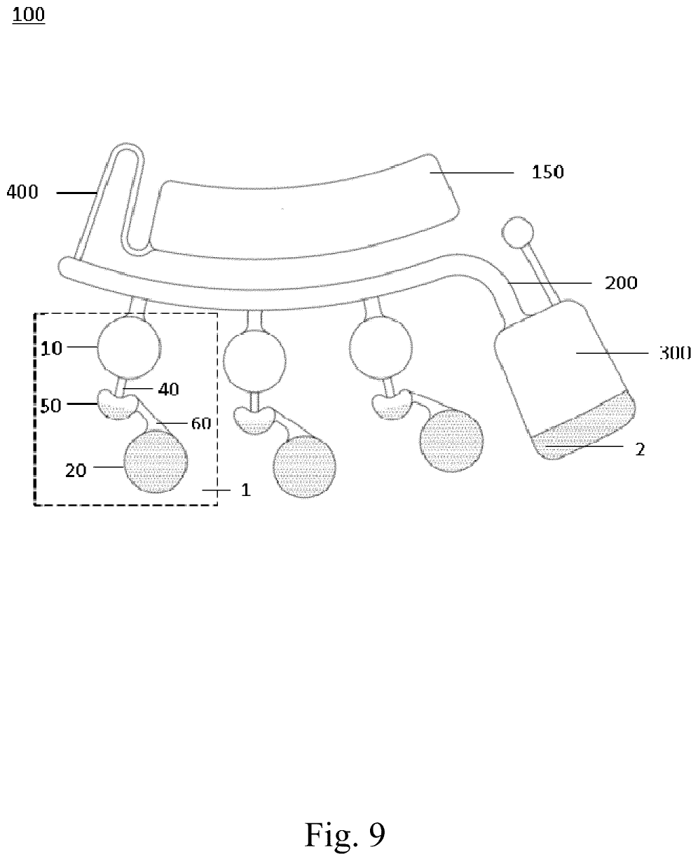

Finally, in FIG. 9, once again increase the rotation speed of the centrifugal platform to break the balance between the surface tension of the liquid in the valve body 52 and the atmospheric pressure therein, so that the testing samples 2 in the first chamber 10 of each detection channel 1 (the first chamber 10 of the second detection channel contains the original testing sample that has not reacted with the reagent, and the first chambers 10 of the first and third detection channels contain the testing sample that the reagent has reacted therewith) flow to the second chambers 20. Among the three detection channels, the second chambers 20 of the second and third detection channels store the second reagent 22, so that the testing sample 2 and the second reagent 22 are subjected to the second reaction, and the testing sample of the first detection channel does not react with the second reagent. If the reaction in the second chambers 22 of the second and third detection channel is over, the samples can be collected via detection equipment for analysis to complete the detection step.

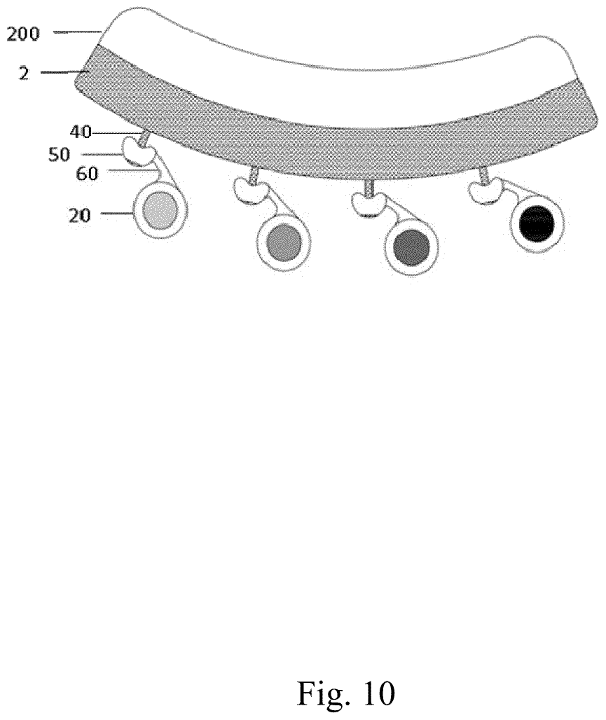

The FIG. 10 shows a schematic diagram of another centrifugal detection device according to a preferred embodiment of the present invention. In FIG. 10, each detection channel 1 only includes an inlet channel 40 directly connected to the dispensing channel 200, a buffer valve 50 connected to the inlet channel 40. The buffer valve 50 includes a valve body 52 disposed at the upper end of the buffer valve 50 and connected to the inlet channel 40 as well as a transient chamber 54 disposed at the lower end of the buffer valve 50. Further, each detection channel 1 includes an outlet channel 60 connected to the buffer valve 50 and a second chamber 20 connected to the outlet channel 60. In other words, in this embodiment, the original first chamber is removed, so that the testing sample 2 in the dispensing channel 200 can directly flow into the buffer valve 50. In other possible implementations, the second chamber 20 can even be removed, and only the detection channel of the buffer valve 50 is remained.

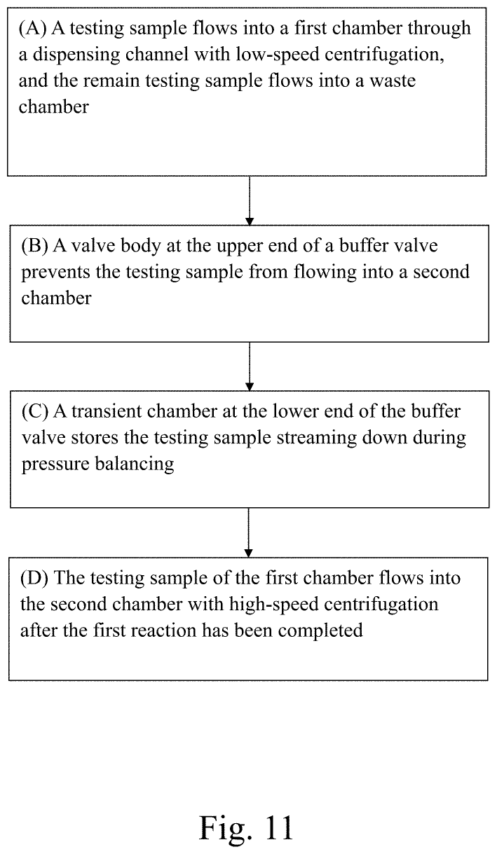

Please refer to FIG. 11, which is a flowchart of a centrifugal detection method according to a preferred embodiment of the present invention. As shown in FIG. 11, the centrifugal detection method includes two pre-steps (a) injecting the testing sample into a chamber, centrifuging the testing sample at a high speed to enable the testing sample flow into a capillary tube; and (b) centrifuging at low speed to make the testing sample flow into the dispensing channel along the capillary tube. Next, in step (A), proceed with the low-speed centrifugation, so that a testing sample which is stored in a dispensing channel flows to a first chamber where a first reagent is stored, and the testing sample along with the first reagent performs a first reaction (the excess testing sample flows to a waste chamber). In step (B), a valve body at the upper end of a buffer valve blocks the testing sample from flowing to a second chamber. In step (C), a transient chamber at the lower end of the buffer valve stores the testing sample dropped when the air pressure is balanced. In step (D), after the first reaction is completed, centrifuge at high speed (destroying the surface tension and pressure balance within the valve body) to make the testing sample of the first chamber flow to the second chamber that stores a second reagent, and thus the testing sample performs a second reaction with the second reagent. Finally, after all the reactions in the second chambers of all the detection channels are completed, samples can be collected for analysis through the detection equipment.

Finally, please refer to FIG. 12, which is a schematic diagram of a centrifugal detection system of a preferred embodiment of the present invention. As shown in FIG. 12, the centrifugal detection system of this embodiment includes a centrifugal platform 500, one of the aforementioned centrifugal detection devices 100 is disposed on the centrifugal platform 500, and at least one detection equipment 600 is connected to the centrifugal detection device 100. Furthermore, the at least one detection equipment is connected to the first chamber 10 or the second chamber 20 of the centrifugal detection device 100, so that a plurality of detection equipment 600 are disposed on different rotation radii of the centrifugal platform 500 (or centrifugal detection device 100). Specifically, the background value detection can be done on the rotation radius of the first chamber 10, and the final detection can be done on the rotation radius of the second chamber 20. However, the actual number of chambers of the centrifugal detection device 100 and the setting position and number of the detection equipment 600 can be modified according to the requirements of users, where the present invention is not limited.

The centrifugal detection channel, the detection device and the detection method mentioned above can all be applied to the field of biomedical detection for various indicators of body fluids such as human or animal blood, plasma, urine, saliva, semen, spinal cord, or amniotic fluid in order to fully perform the automated detection. Otherwise, the present invention can also be used in the field of environmental detection to detect organic or inorganic oxides in the environment. Moreover, the present invention can also be used in the field of food safety to detect toxic and harmful substances, bacteria, or viruses in food. Likewise, the present invention can be used in the fields of pharmacy and chemical industry to conduct various detections of the pharmaceutical ingredients and chemical products. At last, the detection further includes blood coagulation (PT, APTT, TT, FIB, DD, FDP) detection, immunological detection or molecular detection, such as homogeneous chemiluminescence (Light Initiated Chemiluminescent Assay, LiCA) or immunoturbidimetric method (Turbidimetric inhibition immunoassay, TINIA) and other detection technologies.

In the testing sample, if the sample concentration is high, it is allowed to add the replacement liquid while injecting the sample with regard to the centrifugal detection channel, the detection device, and the detection method thereof If the concentration of the test substance in the sample is appropriate, it is only required to add the sample. In terms of the analysis of blood biochemical indicators, the replacement liquid can be added simultaneously during the adding process of the anticoagulated blood. In addition to the analysis of blood biochemical indicators, the application also includes the coagulation detection, immunological detection or molecular detection.

On top of that, the aforementioned centrifugal detection channel and the detection device can also be applied to common microfluidic discs, microfluidic plates or microfluidic chips, and the shape may be circular or fan shaped. The microfluidic discs, microfluidic plates or microfluidic chips also includes structural designs such as a whole blood injection chamber, a plasma quantitative chamber, a whole blood quality control chamber, a diluent injection chamber, a diluent injection chamber, or a diluent quality control chamber.

As is understood by a person skilled in the art, the foregoing preferred than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

What is claimed is:

1. A centrifugal detection channel, comprising:
a first chamber;
at least one inlet channel, connected with the first chamber;
at least one buffer valve, connected with the at least one inlet channel;
wherein each of the at least one buffer valve comprises:
a valve body, disposed at upper part of the at least one buffer valve and connected with the at least one inlet channel; and
a transient chamber, disposed at lower part of the at least one buffer valve;
at least one outlet channel, connected with the at least one buffer valve; and
at least one second chamber, connected with the at least one outlet channel.

2. The centrifugal detection channel as claimed in claim 1, wherein the first chamber stores a first reagent and the at least one second chamber stores a second reagent.

3. The centrifugal detection channel as claimed in claim 2, wherein the first reagent and the second reagent comprise lyophilization reagent, volatilizing reagent, packaged liquid reagent or a combination thereof.

4. The centrifugal detection channel as claimed in claim 1, wherein the at least one inlet channel and the at least one outlet channel comprises microfluidic channel or capillary tube.

5. The centrifugal detection channel as claimed in claim 1, wherein the centrifugal detection channel further comprises:
a background channel, connected with the at least one buffer valve; and
a background chamber, connected with the background channel.

6. The centrifugal detection channel as claimed in claim 3, wherein the centrifugal detection channel further comprises:
a second inlet channel, connected with the at least one second chamber;
a second buffer valve, connected with the second inlet channel;
a second outlet channel, connected with the second buffer valve; and
a third chamber, connected with the second outlet channel.

7. A centrifugal detection device, comprising:
a dispensing channel;
a waste chamber, connected with the dispensing channel;
at least one centrifugal detection channel, individually connected with the dispensing channel, wherein every at least one centrifugal detection channel comprises:
a first chamber;
an inlet channel, connected with the first chamber;
a buffer valve, connected with the inlet channel, wherein the buffer valve comprises:
a valve body, disposed at upper part of the buffer valve and connected with the inlet channel; and
a transient chamber, disposed at lower part of the buffer valve;
an outlet channel, connected with the buffer valve; and
a second chamber, connected with the outlet channel.

8. A centrifugal detection method, comprising:
(A) a testing sample flowing into a first chamber through a dispensing channel with low-speed centrifugation, and the remain testing sample flowing into a waste chamber;
(B) a valve body at upper part of a buffer valve preventing the testing sample flowing into a second chamber;
(C) a transient chamber at lower part of the buffer valve storing the testing sample streaming down during pressure balancing; and
(D) the testing sample of the first chamber flowing into the second chamber with high-speed centrifugation after the first reaction has been completed.

9. A centrifugal detection system, comprising:
a centrifugal platform;
a waste chamber, connected with a dispensing channel;
at least one centrifugal detection channel, disposed on the centrifugal platform,
wherein each at least one centrifugal detection channel comprises:
a first chamber;
an inlet channel, connected with the first chamber;
a buffer valve, connected with the inlet channel, wherein the buffer valve comprises:
a valve body, disposed at upper part of the buffer valve and connected with the inlet channel; and
a transient chamber, disposed at the lower part of the buffer valve;
an outlet channel, connected with the buffer valve;
a second chamber, connected with the outlet channel; and
at least one detection equipment, connected with the at least one centrifugal detection channel.

10. The centrifugal detection system as claimed in claim 9, wherein the detection equipment performs a test on the first chamber or the second chamber.
